(19) United States
(12) Patent Application Publication
(10) Pub. No.: US 2006/0044467 A1
(43) Pub. Date: Mar. 2, 2006

(54) Film mode detection apparatus capable of detecting bad edit and method thereof

(76) Inventors: Young-ho Lee, Yongin-si (KR); Seung-joon Yang, Seoul (KR)

Correspondence Address: STANZIONE & KIM, LLP, 919 18TH STREET, N.W., SUITE 440, WASHINGTON, DC, 20006, US

(21) Appl. No.: 11/210,818

(22) Filed: Aug. 25, 2005

(30) Foreign Application Priority Data
Aug. 26, 2004 (KR) 2004-67504

(51) Int. Cl. H04N 7/01

(52) U.S. Cl. 348/441; 348/700

(57) ABSTRACT

A film mode detection apparatus capable of detecting a bad edit and a method thereof that can detect a bad edit independently of a film pattern. The film mode detection apparatus includes a pattern generation unit to generate a pattern using difference values of information between sequential fields of an input image, a bad edit detection unit to detect extremum values of the difference values of the information between the fields and to judge whether a present field corresponds to a bad edit according to variances of the detected extremum values, and a decision unit to decide whether the input image is a film image using pattern information generated from the pattern generation unit and bad edit detection information from the bad edit detection unit. Accordingly, the apparatus can cope with all kinds of bad edits and thus can prevent an error during the judgment of a film mode.

### CROSS-REFERENCE TO RELATED APPLICATIONS

This application claims benefit under 35 U.S.C. §119 from Korean Patent Application No. 2004-67504, filed with the Korea Industrial Property Office on Aug. 26, 2004, the disclosures of which are incorporated herein by reference.

### BACKGROUND OF THE INVENTION

1. Field of the Invention

The present general inventive concept relates to a film mode detection apparatus capable of detecting a bad edit and a method thereof, and more particularly to a film mode detection apparatus capable of detecting a bad edit and a method thereof that can detect a bad edit independently of a film pattern.

2. Description of the Related Art

Movies generally use a progressive system that processes an image at a speed of 24 sheets of pictures per second, instantaneously stores every picture in a film and progressively projects the pictures on a screen. By contrast, with television (TV), the image processing speed is different from that of a movie according to the color TV transmission system. In the NTSC (National Television System Committee) color TV system, 30 sheets of pictures per second are transmitted, and in the PAL (Phase Alternation by Line) system or SECAM (Sequential Couleur a Memoire) system, 25 sheets of pictures per second are transmitted. In television (TV), since an image is basically transmitted over the air, each picture is filmed and transmitted through scanning of several hundreds of scanning lines, and then displayed on a screen of a Braun tube by scanning.

Additionally, TV uses an interlaced scanning method that divides one picture (i.e., one frame) into two fields and alternately scans the two fields in order to effectively present a moving image using limited scanning lines. Accordingly, the NTSC system processes 60 fields of image per second, and the PAL or SECAM system processes 50 fields of image per second.

Meanwhile, in the case in which a movie is televised through a TV, the picture speed should be adjusted. Since the number of pictures per second of the movie is different from that of the TV, they should be adjusted to correspond with each other. If a movie is reproduced through TV without matching the number of pictures with that of TV, it is displayed on TV screen at a picture speed greater than a normal speed. In the case of transmitting the movie through the NTSC TV system, 60 fields should be obtained from 24 pictures (i.e., frames) per second, that is, two fields should be obtained from 2 pictures, in order to match the picture speed. Generally, a “3:2 pull-down” system, which scans three fields with respect to one picture, and scans two fields with respect to the other picture, is used.

Additionally, in the case of transmitting a movie through the PAL or SECAM TV system, 50 fields should be obtained from 25 pictures (i.e., frames) per second, that is, two fields should be obtained from each frame. This system, which scans two fields with respect to one field, is called a “2:2 pull-down” system.

Bad-edit detection is to detect a loss of such a pull-down regularity caused by a wrong order of streams of a 3:2 pull-down image or a 2:2 pull-down image in an image editing process.

FIG. 1A is a block diagram briefly illustrating the construction of a conventional film mode detection apparatus capable of detecting a bad edit, and FIG. 1B is a block diagram illustrating the detailed construction of the apparatus of FIG. 1A.

As illustrated in FIGS. 1A and 1B, the conventional film mode detection apparatus capable of detecting a bad edit includes a film pattern detection unit 100, a bad edit judgment unit 200 and a film decision unit 300. Here, the film pattern detection unit 100 includes a previous field storage unit 103, a present field storage unit 105, a next field storage unit 107, a 3:2 pull-down main detection unit 107, a 3:2 pull-down sub-detection unit 111, a 2:2 pull-down main detection unit 113 and a 2:2 pull-down sub-detection unit 115.

The previous field storage unit 103, present field storage unit 105 and next field storage unit 107 of the film pattern detection unit 100 respectively store the previous field input previous to the present field, the presently input field and the next field input next to the present field with respect to an input image signal. The 3:2 pull-down main detection unit 109 and the 2:2 pull-down main detection unit 113 calculate a difference of pixel values between sequentially input fields, generate a pattern based on a specified threshold value, and compare the generated pattern with a preset basic pattern of a bad edit.

For example, the 3:2 pull-down sub-detection unit 109 and the 2:2 pull-down sub-detection unit 113 calculate the pixel value difference between the previous field and the present field, output “1” if the pixel value difference is larger than the specified threshold value and output “0” if the pixel value difference is smaller than the threshold value to generate a pattern, and then compare the generated pattern with the preset basic pattern of the bad edit. At that time, the preset basic pattern of the bad edit becomes different according to the 3:2 pull-down sub-detection unit 109 and the 2:2 pull-down sub-detection unit 113.

The 2:2 pull-down main detection unit 111 and the 3:2 pull-down main detection unit 115 calculate an SAD (Sum of Absolute Difference) value between the pixel value difference values between fields calculated by the 3:2 pull-down sub-detection unit 109 and the 2:2 pull-down sub-detection unit 113, generate a pattern based on the specified threshold value and then compare the generated pattern with the preset basic value of the bad edit in the same manner as the 3:2 pull-down sub-detection unit 109 and the 2:2 pull-down sub-detection unit 113. That is, the 2:2 pull-down main detection unit 111 and the 3:2 pull-down main detection unit 115 generate the pattern using the SAD value between the fields, not using the pixel value difference between the fields.

Meanwhile, the bad edit judgment unit 200 judges the existence/nonexistence of the bad edit by comparing the patterns generated based on the pixel value differences between fields and the SAD values calculated by the film pattern generation unit 100 with the preset basic pattern of the bad edit. If the patterns generated by the 3:2 pull-down sub-detection unit 109, 2:2 pull-down main detection unit 111, 2:2 pull-down sub-detection unit 113 and 3:2 pull-down main detection unit 115 are equal to the preset basic pattern of the bad edit, the bad edit judgment unit 200 judges that the bad edit exists.

Then, the film decision unit 300 determines whether the input signal is a film signal according to the patterns generated by the film pattern judgment unit 200, and if the bad edit judgment unit 200 judges existence of the bad edit, the film decision unit 300 determines that the present mode is a film mode even if the pattern of the input signal does not coincide with the pattern of the film mode.

However, the conventional film mode detection apparatus capable of detecting the bad edit has problems in that since it detects the bad edit according to the film patterns, it is impossible to cope with the bad edit if the patterns cross each other. Additionally, in order to detect the bad edit, the apparatus should compare all the patterns detected from the input image with the preset pattern.

### SUMMARY OF THE INVENTION

The present general inventive concept provides a film mode detection apparatus capable of detecting a bad edit and a method thereof that can cope with all kinds of bad edits by detecting the bad edit independently of a film pattern.

Additional aspects and advantages of the present general inventive concept will be set forth in part in the description which follows and, in part, will be obvious from the description, or may be learned by practice of the general inventive concept.

The foregoing and other aspects and advantages of the present general inventive concept are achieved by providing a film mode detection apparatus capable of detecting a bad edit, the apparatus including a pattern generation unit to generate a pattern using difference values of information between sequential fields of an input image, a bad edit detection unit to detect extremum values of the difference values of the information between the fields and to judge whether a present field corresponds to a bad edit depending on variances of the detected extremum values, and a decision unit to decide whether the input image is a film image using pattern information generated from the pattern generation unit and bad edit detection information from the bad edit detection unit.

Here, the difference value of the information between the fields may be any one of a difference value between pixels, a difference value between judder amounts, a difference value between SAD (Sum of Absolute Difference) values and a motion estimation value.

The bad edit detection unit may include a first field difference detection unit to detect the difference values of the information between the fields from a first field and a second field of the input image sequentially input, a second field difference detection unit to detect the difference values of the information between the fields from the second field and a third field next to the second field of the input image, an extremum value detection unit to detect the extremum values of the difference values of the information between the fields detected by the first field difference detection unit and the second field difference detection unit, an operation unit to calculate the variances of the extremum values, and a judgment unit to judge whether the second field corresponds to the bad edit by comparing the first variance calculated by the operation unit using the previous field of the first field, the first field and the second field with the second variance calculated by the operation unit using the first field, the second field and the third field.

The bad edit detection unit may further include a first buffer to sequentially store the extremum values detected by the extremum value detection unit in the order of input fields, and a second buffer to sequentially store the variances calculated by the operation unit in the order of input fields.

Here, if the difference value of the information between the fields is the difference value between pixels, the difference between judder amounts and the difference value between SAD (Sum of Absolute Difference) values, the extremum value detection unit detects minimum values among the detected difference values of the information between the fields, and if the difference value of the information between the fields is the motion estimation value, the extremum value detection unit detects maximum values among the detected difference values of the information between the fields.

In this case, the variance is any one of an average, a standard deviation and a dispersion of the extremum values.

The judgment unit judges that the present field is the bad edit if the difference value between the first variance and the second variance is larger than a specified value.

Meanwhile, a video signal processing apparatus judges whether the input image is a film image using the film mode detection apparatus capable of detecting the bad edit according to the present invention, and adaptively performs an interpolation according to a result of judgment.

The foregoing and/or other aspects and advantages of the present general inventive concept are also achieved by providing a film mode detection method capable of detecting a bad edit, which comprises generating a pattern using difference values of information between sequential fields of an input image, detecting the difference values of the information between the fields from a first field and a second field and the difference values of the information between the fields from the second field and a third field using the sequentially input first, second and third fields, detecting extremum values of the difference values of the information between the fields detected from the first field and the second field and the difference values of the information between the fields detected from the second field and the third field, calculating variances of the extremum values, judging whether the second field corresponds to the bad edit by comparing the first variance calculated using a previous field of the first field, the first field and the second field with the second variance calculated using the first field, the second field and the third field, and deciding whether the input image is a film image using the pattern generated at the generating operation and a result of decision at the judging operation.

Here, the difference value of the information between the fields may be any one of a difference value between pixels, a difference value between judder amounts, a difference value between SAD (Sum of Absolute Difference) values and a motion estimation value.

In this case, if the difference value of the information between the fields is the difference value between pixels, the difference between judder amounts and the difference value between SAD (Sum of Absolute Difference) values, minimum values are detected among the difference values of the information between the fields detected at the operation of detecting extremum values and if the difference value of the information between the fields is the motion estimation value, maximum values are detected among the difference values of the information between the fields detected at the operation of detecting extremum values.

The film mode detection method may further include sequentially storing the detected extremum values in the order of input fields, and sequentially storing the calculated variances in the order of input fields.

In this case, the variance is any one of an average, a standard deviation and a dispersion of the extremum values.

At the judging operation, it is judged that the present field is the bad edit if the difference value between the first variance and the second variance is larger than a specified value.

The foregoing and/or other aspects and advantages of the present general inventive concept are also achieved by providing a film mode detection apparatus capable of detecting a bad edit, including a bad edit detection unit to detect extremum values of the difference values of information between sequential fields of an input image and to judge whether a present field corresponds to a bad edit depending on variances of the detected extremum values; and a decision unit to decide whether the input image is a film image using bad edit detection information from the bad edit detection unit and a pattern using difference values of information between sequential fields of the input image.

The foregoing and/or other aspects and advantages of the present general inventive concept are also achieved by providing film mode detection method capable of detecting a bad edit, including generating a pattern using difference values of information between sequential fields of an input image, detecting judders of a first field and a second field of the input image sequentially input, and detecting judders of the second field and a third field of the input image sequentially input, counting the judders detected between the first field and the second field and between the second field and the third field, detecting the minimum values among the judder amounts counted, calculating variances of the minimum values between the first field and the second field and between the second field and the third field, calculate the variances of the minimum values, and judging whether the present field corresponds to the bad edit by comparing the variances of the minimum values for the previous fields with the variances of the minimum values of the present field calculated in the calculating operation.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A and 1B are block diagrams illustrating the construction of a conventional film mode detection apparatus capable of detecting a bad edit;

FIG. 2 is a block diagram illustrating the construction of a film mode detection apparatus capable of detecting a bad edit, according to an embodiment of the present general inventive concept;

FIGS. 3A to 3C are block diagrams illustrating exemplary embodiments of the film mode detection apparatus of FIG. 2;

FIGS. 4A and 4B are views illustrating a relation between a bad edit and a variance;

FIG. 5 is a block diagram explaining an interpolation using a result of bad edit detection, according to an embodiment of the present general inventive concept; and

FIG. 6 is a flowchart illustrating a film mode detecting method capable of detecting a bad edit according to an embodiment of the present general inventive concept.

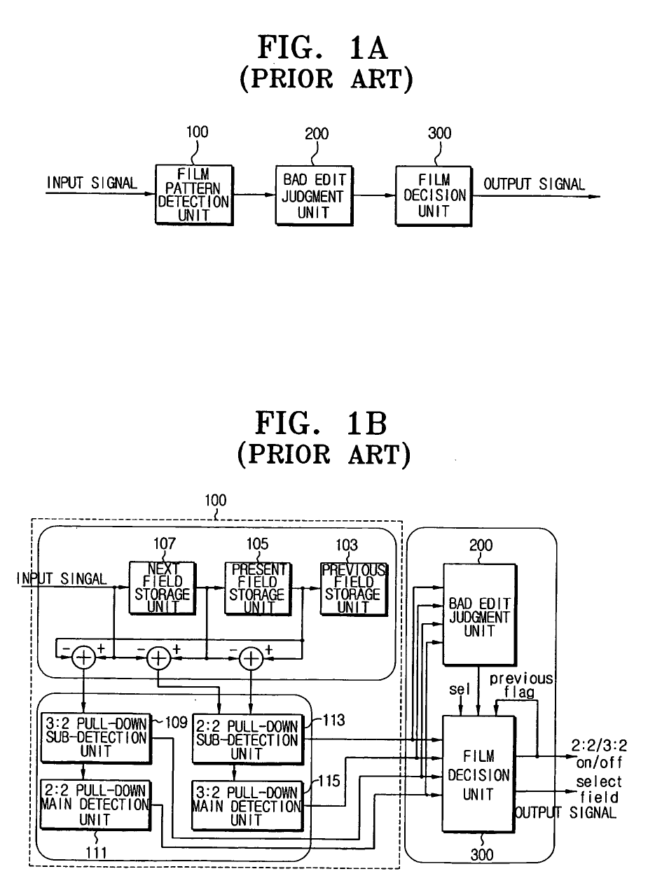

### DETAILED DESCRIPTION OF THE PREFERRED EMBODIMENTS

Certain embodiments of the present general inventive concept will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the general inventive concept. Thus, it is apparent that the present general inventive concept can be carried out without those defined matters. Also, well-known functions or constructions are not described in detail since they would obscure the general inventive concept in unnecessary detail.

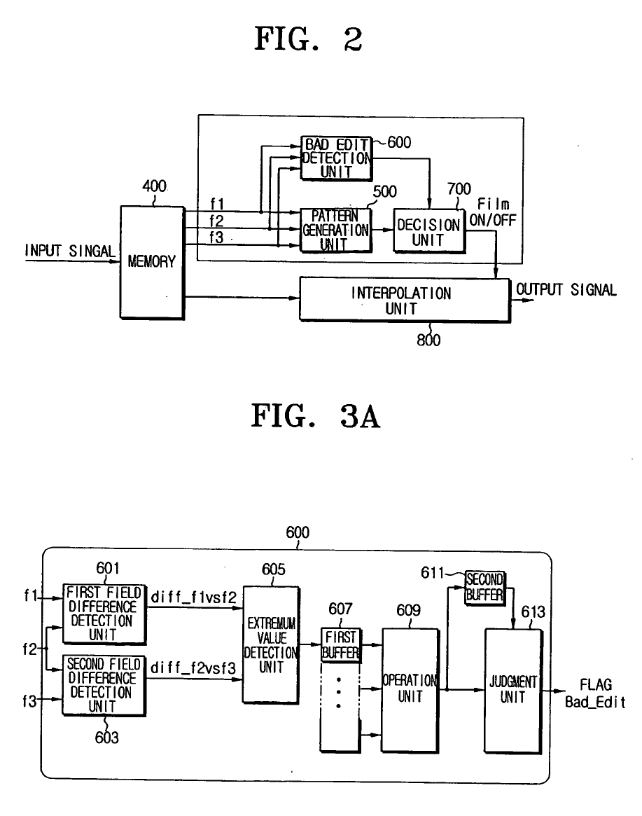

FIG. 2 is a block diagram illustrating the construction of a film mode detection apparatus capable of detecting a bad edit according to an embodiment of the present general inventive concept.

Referring to FIG. 2, the film mode detection apparatus capable of detecting a bad edit according to the present embodiment includes a memory 400, a pattern generation unit 500, a bad edit detection unit 600 and a decision unit 700.

The memory 400 stores input fields.

The pattern generation unit 500 generates a pattern using a first field, a second field and a third field sequentially stored in the memory 400. Specifically, the pattern generation unit 500 calculates differences of pixel values between neighboring fields sequentially input, and if the pixel value difference between the fields is greater than a specified threshold value, it generates a “1,” while if the pixel value difference between the fields is less than the specified threshold value, it generates a “0” to generate the pattern.

The bad edit detection unit 600 detects whether an input image corresponds to a bad edit using variances calculated based on the difference values of information between fields sequentially input and stored in the memory 400. Specifically, the bad edit detection unit 600 detects the minimum values and the maximum values among the difference values of the information between the fields sequentially detected using the first field, the second field and the third field. Then, the bad edit detection unit 600 detects the field that has the variances of the minimum values or the variances of the maximum values having abrupt differences therebetween by comparing the variances of the detected minimum values or the variances of the detected maximum values with the variances of the pre-stored minimum values or the variances of the pre-stored maximum values, respectively.

The decision unit 700 decides whether the input image corresponds to a film mode based on the input signal from the pattern generation unit 500 and the bad edit detection unit 600. That is, the decision unit 700 decides whether the input image corresponds to the film image using a progressive method.

If the pattern of the input image generated from the pattern generation unit 500 coincides with the pattern of the film image, the decision unit 700 decides that the input image corresponds to the film mode. Meanwhile, if the bad edit is detected by the bad edit detection unit 600, the decision unit 700 decides that the input image corresponds to the film mode even if the input image does not coincide with the pattern of the film image.

An interpolation unit 800 performs an interpolation of the image according to the decision of the decision unit 700. That is, if the decision unit 700 decides that the input image does not correspond to the film mode, the interpolation unit 800 performs the interpolation by a deinterlacing method such as a motion adaptive deinterlacing method, a motion compensation deinterlacing method, etc. However, if the decision unit 700 decides that the input image corresponds to the film mode, the interpolation unit 800 generates the image by combining the successive fields sequentially input.

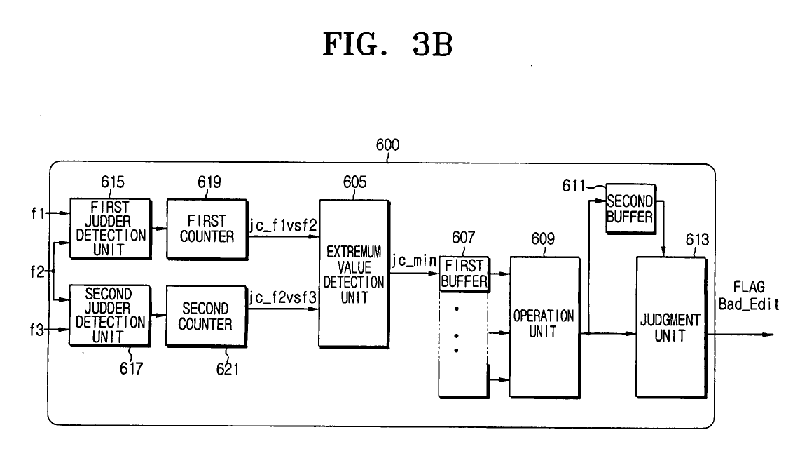

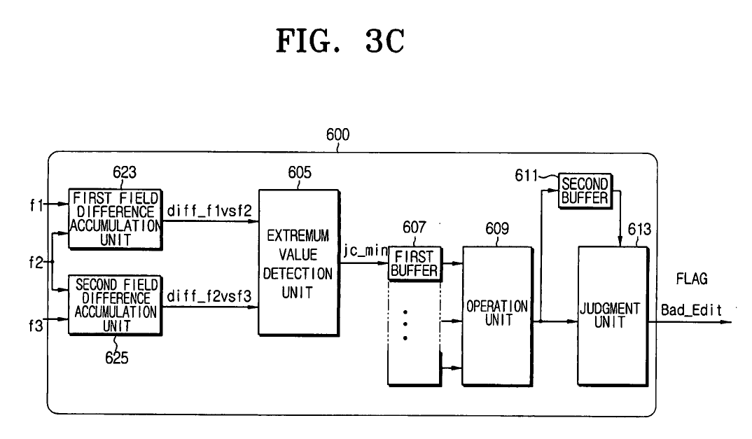

FIGS. 3A to 3C are block diagrams illustrating exemplary embodiments of the bad edit detection unit 600 of the film mode detection apparatus of FIG. 2. Specifically, FIG. 3A illustrates an embodiment of construction of a bad edit detection unit 600 that detects the bad edit using the difference values of the information between the successive fields sequentially input. FIG. 3B illustrates an embodiment of the construction of a bad edit detection unit 600 where the difference value of the information between the successive fields sequentially input corresponds to the amount of judder. FIG. 3C illustrates an embodiment of the construction of a bad edit detection unit 600 where the difference value of the information between the successive fields sequentially input corresponds to the SAD value. The bad edit can be detected using the motion estimation of diverse field different information in addition to the difference between the pixel values, the difference between the judder amounts, and the difference between the SAD values as the difference value between the successive fields sequentially input.

Referring to the embodiment of FIG. 3A, the bad edit detection unit 600 includes a first field difference detection unit 601, a second field difference detection unit 605, an extremum value detection unit 605, a first buffer 607, an operation unit 609, a second buffer 611 and a judgment unit 613.

The first field difference detection unit 601 detects the difference values between the first field f1 and the second field f2 sequentially input, and the second field difference detection unit 603 detects the difference values between the second field f2 and the third field f3 sequentially input.

The extremum detection unit 605 detects the minimum values or the maximum values among the values detected by the first field difference detection unit 601 and the second field difference detection unit 603. If the difference value of the information between the successive fields is the difference between the pixel values, the difference between SAD values or the difference between the judder amounts, the extremum value detection unit 605 detects the minimum values among the values detected by the first field difference detection unit 601 and the second field difference detection unit 603. In contrast, if the difference value of the information between the successive fields is the motion estimation value, the extremum value detection unit 605 detects the maximum values among the values detected by the first field difference detection unit 601 and the second field difference detection unit 603.

The first buffer 607 sequentially stores the minimum values or the maximum values detected by the extremum value detection unit 605 in the order of input fields.

The operation unit 609 calculates the variance of the extremum values such as an average, a standard deviation, and a dispersion of the extremum values using the minimum values or the maximum values input from the first buffer 607. Additionally, the second buffer 611 stores the variances calculated by the operation unit 609. The judgment unit 613 judges whether the present field corresponds to the bad edit by comparing the variances of the minimum values or the variance of the maximum values stored in the second buffer 611 with the variances of the minimum values or the variance of the maximum values calculated by the operation unit 609. That is, the operation unit 609 judges that the present field corresponds to the bad edit if the variances of the present field calculated by the operation unit 609 are abruptly varied in comparison to the variances of the previous fields stored in the second buffer 611.

Referring to the embodiment of FIG. 3B, the bad edit detection unit 600 includes a first judder detection unit 615, a second judder detection unit 617, a first counter 619, a second counter 621, an extremum value detection unit 605, a first buffer 607, an operation unit 609, a second buffer 611 and a judgment unit 613.

The first judder detection unit 615 and the second judder detection unit 617 detect judders of the fields sequentially input, and the first counter 619 and the second counter 621 count the judders detected by the first judder detection unit 615 and the second judder detection unit 617, respectively. The extremum value detection unit 605 detects the minimum values among the judder amounts counted by the first counter 619 and the second counter 621.

The first buffer 607 sequentially stores the detected minimum values, and the operation unit 609 calculates the variances of the minimum values stored in the first buffer 607. The second buffer 611 stores the variances of the minimum values calculated for the sequentially input fields by the operation unit 609, and the judgment unit 613 judges whether the present field corresponds to the bad edit by comparing the variances of the minimum values for the previous fields stored in the second buffer 611 with the variances of the minimum values of the present field calculated by the operation unit 609.

Referring to the embodiment of FIG. 3C, the bad edit detection unit 600 includes a first field difference accumulation unit 623, a second field difference accumulation unit 625, an extremum value detection unit 605, a first buffer 607, an operation unit 609, a second buffer 611 and a judgment unit 613. The first field difference accumulation unit 623 and the second field difference accumulation unit 625 calculate the SAD values between successive fields sequentially input. The extremum value detection unit 605 detects the minimum values from the SAD values. The first buffer 607, the operation unit 609, the second buffer 611 and the judgment unit 613 operate in the same manner as those explained with reference to the embodiment of FIG. 3B.

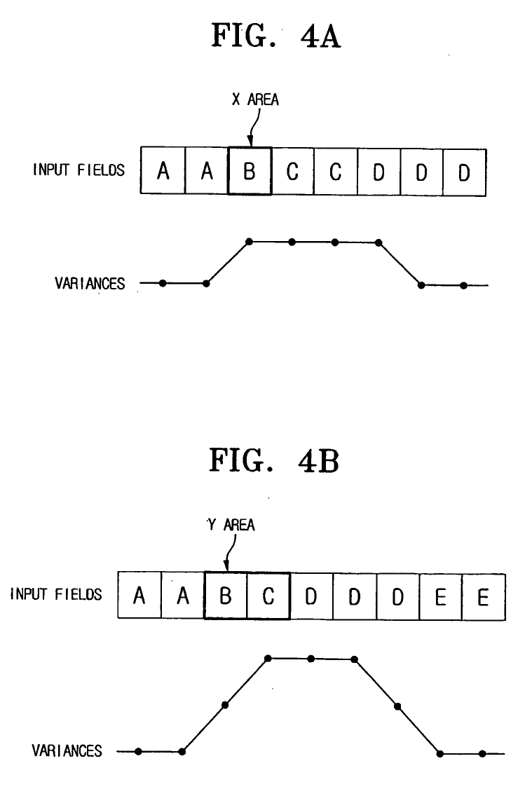

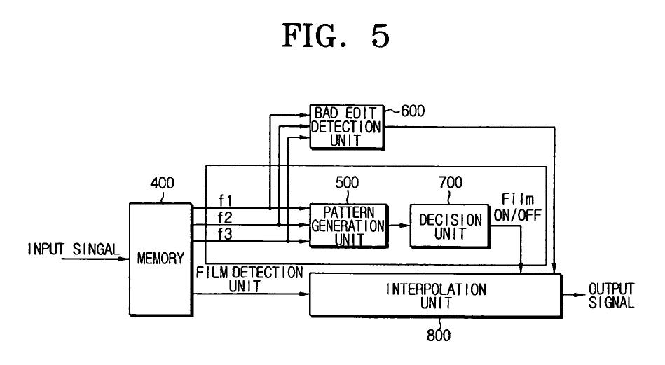

FIGS. 4A and 4B are views illustrating the relation between the bad edit and the variance. In FIGS. 4A and 4B, the variances according to the input fields having the bad edit are illustrated. Also, in FIGS. 4A and 4B, ‘X’ and ‘Y’ areas indicate edited areas.

Referring to FIG. 4A, the ‘X’ area corresponds to the bad edit, and before the input fields are edited, an ‘A’ field and a ‘B’ field are located on the left and right of a basic ‘B’ field of the ‘X’ area, respectively. If the minimum value of the pixel value differences between the successive fields is detected using the left ‘A’ field, the basic ‘B’ field of the ‘X’ area and the right ‘B’ field before the input fields are edited, the minimum value between the difference value between the left ‘A’ field and the ‘B’ field of the ‘X’ area and the difference value between the ‘B’ field of the ‘X’ area and the right ‘B’ field becomes the difference value between the basic ‘B’ field of the ‘X’ area and the right ‘B’ field. Also, if the minimum value of the pixel value differences between the successive fields is detected using three ‘A’ fields located on the left of the ‘B’ field of the ‘X’ area before the input fields are edited, the minimum value becomes the difference value between the ‘A’ field and the ‘A’ field, i.e., a difference between the second ‘A’ field and the first ‘A’ field, or a difference between the second ‘A’ field and the third ‘A’ field.

Accordingly, if the variance of the minimum values detected using the three fields, i.e., the left ‘A’ field, the ‘B’ field of the ‘X’ area and the right ‘B’ field is compared with the variance of the minimum values detected using the three ‘A’ fields located on the left of the ‘B’ field of the ‘X’ area before the input fields are edited, the difference between them is not great, and thus it is judged that the ‘B’ field of the X area does not correspond to the bad edit.

However, if the minimum value of the pixel value differences between the successive fields is detected using the left ‘A’ field, the basic ‘B’ field of the ‘X’ area and the right ‘C’ field after the input fields are edited as illustrated in FIG. 4A, both the difference value between the left ‘A’ field and the ‘B’ field of the ‘X’ area and the difference value between the ‘B’ field of the ‘X’ area and the right ‘C’ field have large values even if the minimum value between the difference value between the left ‘A’ field and the ‘B’ field of the ‘X’ area and the difference value between the ‘B’ field of the ‘X’ area and the right ‘C’ field is detected. Also, if the minimum value of the pixel value differences between the successive fields is detected using the ‘B’ field of the ‘X’ area and two ‘A’ fields located on the left of the ‘B’ field of the ‘X’ area, the difference value between the two ‘A’ fields on the left of the ‘B’ fields of the ‘X’ area becomes the minimum value. Accordingly, if the variance of the minimum values detected using the three fields, i.e., the left ‘A’ field, the ‘B’ field of the ‘X’ area and the right ‘C’ field is compared with the variance of the minimum values detected using the ‘B’ field of the ‘X’ area and the two ‘A’ fields located on the left of the ‘B’ field of the ‘X’ area, the variance of the minimum values detected using the ‘B’ field of the ‘X’ area and the two ‘A’ fields located on the left of the ‘B’ field of the ‘X’ area becomes great, and thus it is judged that the ‘B’ field of the X area corresponds to the bad edit.

In other words, the pull-down image having no bad edit has the characteristic in that at least one field coming from the same progressive frame exists in the neighboring fields. That is, in the neighboring fields of the ‘B’ field of the ‘X’ area, the ‘B’ field that is the field coming from the same progressive frame does not exist due to the edition of the input fields. Accordingly, the ‘B’ field may be detected as the bad edit by the bad edit detection unit 600.

Referring to FIG. 4B, the ‘B’ field and ‘C’ field of a ‘Y’ area are judged as the bad edit in the same manner as described above. That is, even if the minimum value between the difference value between the ‘B’ field and the ‘C’ field and the difference value between the ‘C’ field and a ‘D’ field located on the right of the ‘C’ field is detected, both the two difference values are large, and an abrupt difference appears between the variance of the minimum values between them calculated by the operation unit 609 and the variance of the minimum values detected in the previous fields of the ‘C’ field of the ‘Y’ area, so that the judgment unit 613 judges this as the bad edit.

FIG. 5 is a block diagram explaining the interpolation using the result of bad edit detection, according to an embodiment of the present general inventive concept.

Referring to FIG. 5, an output signal of a bad edit detection unit 600 is directly input to an interpolation unit 800, and thus judders occurring during the interpolation can be prevented. Specifically, if a signal indicating the detection of the bad edit is input from the bad edit detection unit 600 to the interpolation unit 800, the interpolation unit 800 does not perform the interpolation using the fields neighboring the bad edit, but performs the interpolation by diverse methods using information in the field corresponding to the bad edit.

In the case of the bad edit, the field corresponding to the bad edit has field information different from the neighboring fields due to the editing operation. Accordingly, even if a field has been judged as the bad edit and the decision unit 700 has decided that the present mode is the film mode, the interpolation unit 800 does not perform the interpolation using the neighboring fields of the bad edit, but performs the interpolation using the information in the field that is judged as the bad edit, so that the judder occurrence can be prevented.

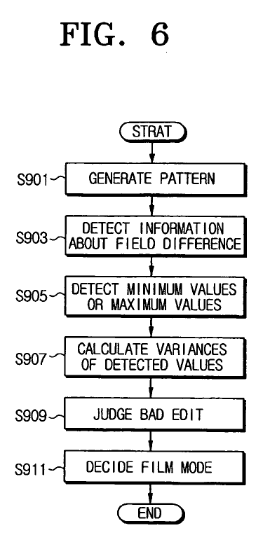

FIG. 6 is a flowchart illustrating a film mode detecting method capable of detecting a bad edit, according to an embodiment of the present general inventive concept.

Referring to FIG. 6, the pattern generation unit 500 generates a pattern using information of the fields output from the memory 400 in which sequentially input fields are stored (operation S901). The pattern generation unit 500 calculates the pixel value difference between the successive fields sequentially input, and if the pixel value difference between the fields is greater than a specified threshold value on the basis of the specified threshold value, the pattern generation unit 500 generates a ‘1’, while if the pixel value difference between the fields is smaller than the threshold value, it generates a ‘0’ to generate the pattern.

The pattern generated by the pattern generation unit 500 is not input to the bad edit detection unit 600 as in the conventional film mode detection apparatus capable of detecting the bad edit, but is input to the decision unit 700. Accordingly, the bad edit detection unit 600 does not judge the occurrence of the bad edit using the pattern information.

Then, the first field difference detection unit 601 and the second field detection unit 603 (FIG. 3A) detect the difference values of the information between the successive fields sequentially input (operation S903). The first field difference detection unit 601 detects the difference value of the information between the first field and the second field, and the second field difference detection unit 601 detects the difference value of the information between the second field and the third field. Here, the difference value of the information between the fields may be the difference between pixel values, the difference of judder amounts, the difference between SAD values, the motion estimation value, etc.

The minimum value or the maximum value is then detected from the difference values of the information between the fields detected by the first field difference detection unit 601 and the second field difference detection unit 603 (operation S905). If the detected difference value of the information between the fields is the difference value between pixel values, the difference value of judder amounts and the difference value between SAD values, the minimum value is detected among the difference values detected by the first field difference detection unit 601 and the second field difference detection unit 603. Meanwhile, if the detected difference value of the information between the fields is the motion estimation value, the maximum value is detected among the difference values detected by the first field difference detection unit 601 and the second field difference detection unit 603. The minimum values or the maximum values of the difference values of the information between the fields detected as above are stored in the first buffer 607.

The operation unit 609 then calculates the variance using the detected minimum values and the maximum values (operation S907). That is, the operation unit 609 calculates the average, the standard deviation, the dispersion, etc., of the minimum value or the maximum value of the difference values of the information between the fields, and stores the variance in the second buffer 611.

Then, the judgment unit judges whether the field corresponds to the bad edit using the variances calculated by the operation unit 609 (operation S909). The variance of the previous fields stored in the second buffer 611 is compared with the variance calculated by the operation unit 609, and if the variance calculated by the operation unit 609 is larger than the variance of the previous fields stored in the second buffer 611, it is judged that the present field corresponds to the bad edit.

Then, the decision unit 700 decides whether the input image is the film image using the result of bad edit detection performed by the bad edit detection unit 600 and the signal from the pattern generation unit 500 (operation S911). If the pattern generated by the pattern generation unit 400 is the film pattern, or if the pattern is detected as the bad edit although the pattern is not the film pattern, the decision unit 700 decides that the input image corresponds to the film mode. By contrast, if the bad edit is not detected in a state that the pattern generated by the pattern generation unit 400 is not the film pattern, the decision unit decides that the input image does not correspond to the film mode.

As described above, it will be apparent that the film mode detection apparatus and method according to various embodiments of the present general inventive concept can cope with all kinds of bad edits by detecting the bad edit independently of a film pattern, and thus can prevent the error during the judgment of the film mode.

Accordingly, the present general inventive concept can prevent the judder due to an error occurring in the film mode judgment, and can keep the film mode operation state by accurately detecting the bad edit, so that the deterioration occurring during the re-operation in the film mode can be prevented after the film mode is off.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A film mode detection apparatus capable of detecting a bad edit, comprising:
a pattern generation unit to generate a pattern using difference values of information between sequential fields of an input image;
a bad edit detection unit to detect extremum values of the difference values of the information between the fields and to judge whether a present field corresponds to a bad edit depending on variances of the detected extremum values; and
a decision unit to decide whether the input image is a film image using pattern information generated from the pattern generation unit and bad edit detection information from the bad edit detection unit.

2. The film mode detection apparatus as claimed in claim 1, wherein the difference value of the information between the fields is any one of a difference value between pixels, a difference value between judder amounts, a difference value between SAD (Sum of Absolute Difference) values and a motion estimation value.

3. The film mode detection apparatus as claimed in claim 1, wherein the bad edit detection unit comprises:
a first field difference detection unit to detect the difference values of the information between the fields from a first field and a second field of the input image sequentially input;
a second field difference detection unit to detect the difference values of the information between the fields from the second field and a third field next to the second field of the input image;
an extremum value detection unit to detect the extremum values of the difference values of the information between the fields detected by the first field difference detection unit and the second field difference detection unit;
an operation unit to calculate the variances of the extremum values; and
a judgment unit to judge whether the second field corresponds to the bad edit by comparing the first variance calculated by the operation unit using the previous field of the first field, the first field and the second field with the second variance calculated by the operation unit using the first field, the second field and the third field.

4. The film mode detection apparatus as claimed in claim 3, wherein the bad edit detection unit further comprises:
a first buffer to sequentially store the extremum values detected by the extremum value detection unit in the order of input fields; and
a second buffer to sequentially store the variances calculated by the operation unit in the order of input fields.

5. The film mode detection apparatus as claimed in claim 3, wherein if the difference value of the information between the fields is the difference value between pixels, the difference between judder amounts and the difference value between SAD (Sum of Absolute Difference) values, the extremum value detection unit detects minimum values among the detected difference values of the information between the fields, and if the difference value of the information between the fields is the motion estimation value, the extremum value detection unit detects maximum values among the detected difference values of the information between the fields.

6. The film mode detection apparatus as claimed in claim 3, wherein the variance is any one of an average, a standard deviation and a dispersion of the extremum values.

7. The film mode detection apparatus as claimed in claim 3, wherein the judgment unit judges that the present field is the bad edit if the difference value between the first variance and the second variance is larger than a specified value.

8. The film mode detection apparatus as claimed in claim 1, further comprising:
an interpolation unit to perform an interpolation of the image according to the decision of the decision unit.

9. The film mode detection apparatus as claimed in claim 8, wherein the interpolation is performed by a deinterlacing operation.

10. The film mode detection apparatus as claimed in claim 1, wherein the bad edit detection unit comprises:
a first judder detection unit to detect judders of a first field and a second field of the input image sequentially input therein;
a second judder detection unit to detect judders of the second field and a third field next to the second field of the input image sequentially input therein;
a first counter to count the judders detected by the first judder detection unit;
a second counter to count the judders detected by the second judder detection unit;
an extremum value detection unit to detect the minimum values among the judder amounts counted by the first counter and the second counter;
an operation unit to calculate the variances of the minimum values; and
a judgment unit to judge whether the present field corresponds to the bad edit by comparing the variances of the minimum values for the previous fields with the variances of the minimum values of the present field calculated by the operation unit.

11. A video signal processing apparatus to judge whether an input image is a film image and to adaptively perform an interpolation according to a result of judgment using a film mode detection apparatus capable of detecting a bad edit of claim 1.

12. A film mode detection apparatus capable of detecting a bad edit, comprising:
a bad edit detection unit to detect extremum values of the difference values of information between sequential fields of an input image and to judge whether a present field corresponds to a bad edit depending on variances of the detected extremum values; and
a decision unit to decide whether the input image is a film image using bad edit detection information from the bad edit detection unit and a pattern using difference values of information between sequential fields of the input image.

13. A film mode detection method capable of detecting a bad edit, comprising:
generating a pattern using difference values of information between sequential fields of an input image;
detecting the difference values of the information between the fields from a first field and a second field and the difference values of the information between the fields from the second field and a third field using the sequentially input first, second and third fields;
detecting extremum values of the difference values of the information between the fields detected from the first field and the second field and the difference values of the information between the fields detected from the second field and the third field;
calculating variances of the extremum values;
judging whether the second field corresponds to the bad edit by comparing the first variance calculated using a previous field of the first field, the first field and the second field with the second variance calculated using the first field, the second field and the third field; and
deciding whether the input image is a film image using the pattern generated at the generating operation and a result of the decision at the judging operation.

14. The film mode detecting method as claimed in claim 13, wherein the difference value of the information between the fields is any one of a difference value between pixels, a difference value between judder amounts, a difference value between SAD (Sum of Absolute Difference) values and a motion estimation value.

15. The film mode detecting method as claimed in claim 14, wherein if the difference value of the information between the fields is the difference value between pixels, the difference between judder amounts and the difference value between SAD (Sum of Absolute Difference) values, minimum values are detected among the difference values of the information between the fields detected at the operation of detecting extremum values, and if the difference value of the information between the fields is the motion estimation value, maximum values are detected among the difference values of the information between the fields detected at the operation of detecting extremum values.

16. The film mode detecting method as claimed in claim 13, further comprising:
sequentially storing the detected extremum values in the order of input fields; and
sequentially storing the calculated variances in the order of input fields.

17. The film mode detecting method as claimed in claim 13, wherein the variance is any one of an average, a standard deviation and a dispersion of the extremum values.

18. The film mode detecting method as claimed in claim 13, wherein at the judging operation, it is judged that the present field is the bad edit if the difference value between the first variance and the second variance is greater than a specified value.

19. A film mode detection method capable of detecting a bad edit, comprising:
generating a pattern using difference values of information between sequential fields of an input image;
detecting judders of a first field and a second field of the input image sequentially input, and detecting judders of the second field and a third field of the input image sequentially input;
counting the judders detected between the first field and the second field and between the second field and the third field;
detecting the minimum values among the judder amounts counted;
calculating variances of the minimum values between the first field and the second field and between the second field and the third field;
calculate the variances of the minimum values; and
judging whether the present field corresponds to the bad edit by comparing the variances of the minimum values for the previous fields with the variances of the minimum values of the present field calculated in the calculating operation.
